(19) United States
(12) Patent Application Publication
(10) Pub. No.: US 2025/0289287 A1
(43) Pub. Date: Sep. 18, 2025

(54) SYSTEM AND METHOD FOR MITIGATING HARMFUL ENVIRONMENTAL CONDITIONS WITHIN AN INTERIOR OF A VEHICLE

(71) Applicant: Adam Price, Springfield, OH (US)

(72) Inventor: Adam Price, Springfield, OH (US)

(21) Appl. No.: 18/605,988

(22) Filed: Mar. 15, 2024

(51) Int. Cl. B60H 1/00

(52) U.S. Cl. CPC B60H 1/00978; B60H 1/00742; B60H 1/00835; B60H 1/00878

(57) ABSTRACT

A system and method are provided for detecting humans or pets located within the interior of a vehicle and mitigating harmful environmental conditions within the interior to protect humans or pets that may have been inadvertently left inside the vehicle and are incapable of voluntarily exiting the vehicle. The system includes a vehicle having an interior space for occupants and an air conditioner for regulating the air temperature within the interior space. The system also includes a detection sensor for detecting whether a person or pet is inside the vehicle and an environmental sensor for detecting the air temperature inside the vehicle. If the system determines that a person or pet is occupying the vehicle and the inside air temperature is above or below a safe level, the system is designed to automatically take corrective actions to regulate the air temperature to prevent serious injury or death to vehicle occupants.

### FIELD OF THE DISCLOSURE

The subject matter of the present disclosure refers generally to a system and method for detecting humans or pets located within the interior of a vehicle and mitigating harmful environmental conditions within the interior to protect humans or pets occupying the vehicle.

### BACKGROUND

Every year children and pets are seriously injured and sometimes die within the interior of vehicles after being unintentionally left in a vehicle by a parent or pet owner. Such injuries or deaths typically occur due to extreme temperatures that develop within the vehicle interior after the child or pet is left in the vehicle with the windows closed and the engine off so that the vehicle air conditioning system is not operating to maintain the interior air temperature at a safe and comfortable temperature for any occupants of the vehicle. In most cases, injuries and deaths occur due to extreme heat, although extreme cold can also cause serious injury and death. During times of warm outdoor temperatures, particularly in the summer months and especially on sunny days, the air temperature within the interior of a vehicle can increase rapidly with the windows closed and the air conditioning system turned off due to a greenhouse effect occurring within the interior of the vehicle. In some cases, it may be a matter of only minutes before the interior air temperature increases to a level that can be life-threatening to children and pets.

Systems have been designed to prevent such problems by providing some type of alert or notification if a child or pet is inadvertently left inside a vehicle. Such known systems may send an alert to the owner of the vehicle through a mobile application or to emergency services to provide emergency assistance. Other known systems may activate audio or visual alarms to alert the driver of the vehicle after the driver exits the vehicle or others in the vicinity of the vehicle. However, such known systems typically require the driver or owner of the vehicle to take some specific action to correct the problem at the time the problem occurs, or the vehicle driver or owner may have to sign up beforehand for a particular service or buy a particular item such as a child car seat having such safety features in order to prevent the problem from occurring. Many parents or pet owners may be unlikely to buy such items or sign up for such services because they may think that it is unlikely that they would allow such a problem to occur in the first place and thus such actions are not necessary or because it simply may not occur to them to do so before such a problem occurs. Systems requiring immediate action by the driver may still result in serious injury or death if the driver does not immediately recognize the alert or notification due to distraction or other reasons. However, leaving a child or pet inside a vehicle can be deadly, sometimes within a very short period of time. Accordingly, it would be beneficial to have a system that is capable of mitigating dangerous environmental conditions within the interior of a vehicle without requiring the vehicle driver or owner to take specific action either beforehand or at the time that the problem occurs.

### SUMMARY

In one aspect, a system and a method for detecting humans or pets located within the interior of a vehicle and mitigating harmful environmental conditions within the interior to protect humans or pets occupying the vehicle are provided. The system is capable of detecting individuals within an interior space of a vehicle and is also capable of detecting whether an environmental condition, such as the air temperature, within the interior space might be hazardous to the individual's health or safety. If the system detects a hazardous condition within the interior of the vehicle while an individual is occupying the interior of the vehicle, the system is designed to automatically take one or more corrective actions to mitigate the hazardous condition without requiring a specific action or response by a user.

The system generally comprises a vehicle having an interior space that is defined at least partially by a window, a detection sensor configured to detect an individual occupying the interior space of the vehicle, an environmental sensor configured to detect at least one environmental condition within the interior space of the vehicle, and a controller that receives an input signal from the detection sensor and an input signal from the environmental sensor. The vehicle includes a window motor configured to move the window between an open position and a closed position and an air conditioner configured to control the air temperature within the interior space of the vehicle. The environmental sensor includes at least a thermometer configured to measure the air temperature within the interior space. The controller is configured to initiate operation of the air conditioner to regulate the air temperature within the interior space of the vehicle and preferably also to initiate operation of the window motor to move the window between the closed position and the open position when an individual is detected within the interior of the vehicle and the air temperature is outside of a threshold limit.

In one embodiment, the system may protect a person or pet from extreme heat within the vehicle interior. In this case, upon receiving an input signal from the detection sensor indicating an air temperature above an upper threshold limit, the controller may be configured to first initiate operation of the window motor to move the window from the closed position to the open position to immediately alleviate the extreme heat. The controller may be further configured to then initiate operation of the air conditioner to cool the air temperature within the interior space of the vehicle after or at the same time as moving the window to the open position. The air conditioner helps to further regulate and cool the interior air temperature. The controller may be further configured to then initiate operation of the window motor to move the window from the open position back to the closed position so that the air conditioner can cool the interior air temperature to a temperature below the outside air temperature.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTON OF THE DRAWINGS

These and other features, aspects, and advantages of the present disclosure will become better understood with regard to the following description, appended claims, and accompanying drawings where:

FIG. 1 shows a system including a vehicle embodying features consistent with the principles of the present disclosure.

FIG. 2 shows a system including a vehicle embodying features consistent with the principles of the present disclosure with a portion of the vehicle removed to show an interior space of the vehicle.

FIG. 3 is a schematic diagram illustrating a system embodying features consistent with the principles of the present disclosure.

FIG. 4 is a schematic diagram illustrating a system embodying features consistent with the principles of the present disclosure.

FIG. 5 a diagram illustrating a flow chart illustrating certain method steps of a method embodying features consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. Although the description generally refers to protecting individuals within rear seating areas of a vehicle, one with skill in the art will understand that the system may be used to protect individuals within other areas of a vehicle without departing from the inventive subject matter described herein.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

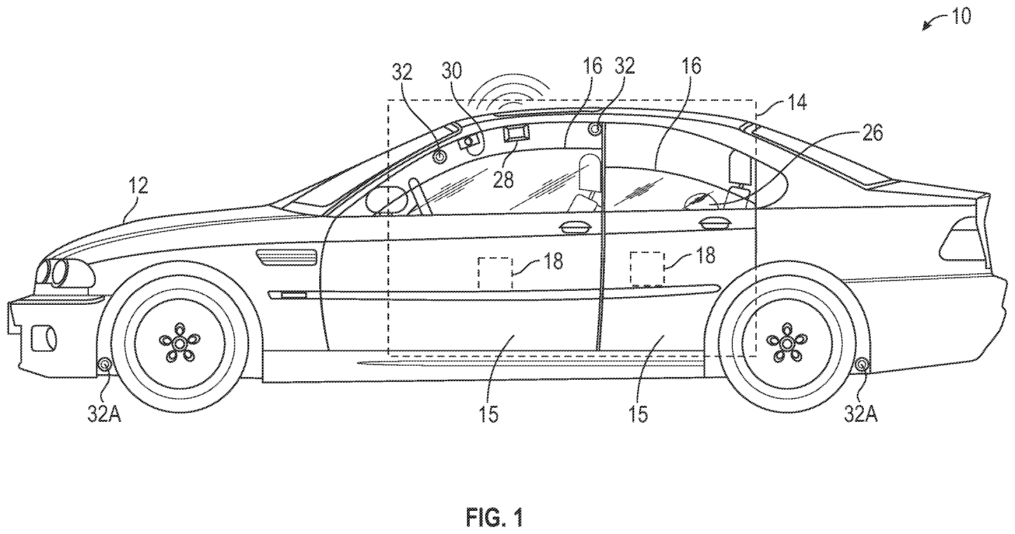

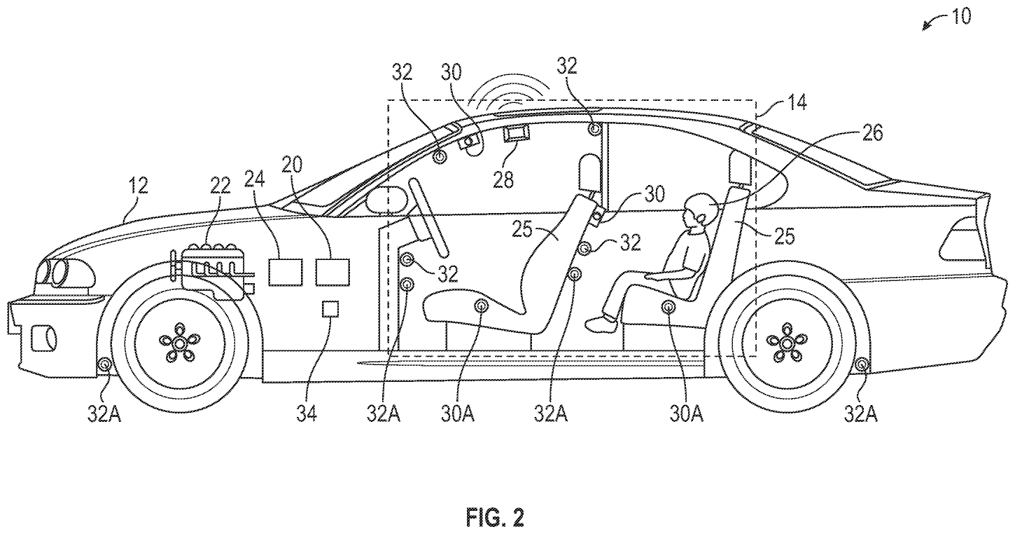

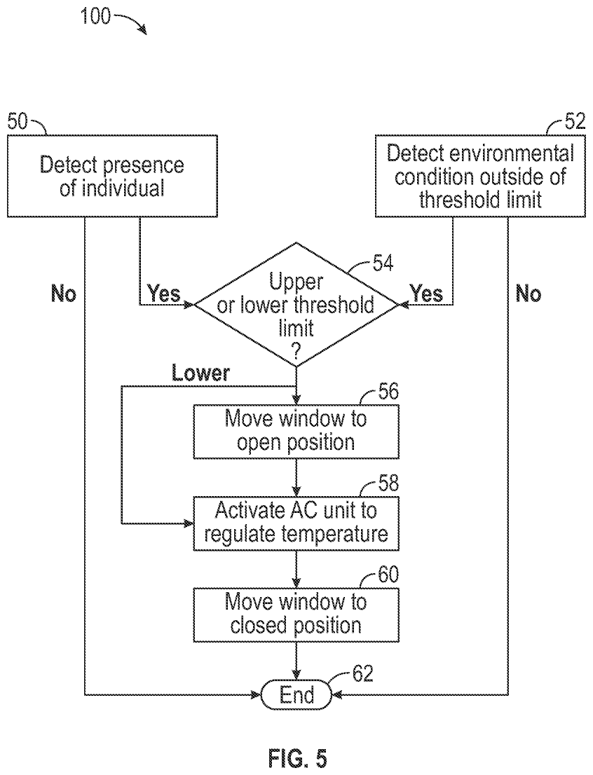

FIGS. 1-4 illustrate embodiments of a system 10 designed for detecting the presence of individuals 26 occupying an interior space 14 of a vehicle 12 and mitigating harmful environmental conditions within the interior space 14 to protect one or more individuals 26 occupying the interior space 14 of the vehicle 12 in order to prevent serious harm or loss of life to the individuals 26. FIG. 5 illustrates certain steps of a method 100 that may be carried out by the system 10 to detect the presence of an individual 26 and mitigate the harmful conditions within the interior space 14. As best seen in FIG. 2, the individual 26 may be a human being, which is often a child that is inadvertently left inside a vehicle 12. In other embodiments, the individual may an animal such as a pet that is left inside the vehicle 12. As shown in FIG. 2, the system 10 may be designed to detect a child 26 in the backseat 25 of the vehicle 12, which is often the location within the interior space 14 in which a child 26 or pet is inadvertently left inside the vehicle 12. However, the system 10 may be designed to detect a child 26 or pet occupying any portion of the interior space 14 of the vehicle 12, including the front seat 25. The system 10 is also designed to detect whether the environmental condition within the interior space 14 of the vehicle 12 may be harmful to the health or safety of the individual 26. If the system 10 determines that a hazardous environmental condition exists within the interior space 14 of the vehicle 12 while an individual 26 is occupying the interior space 14, the system 10 is designed to automatically take one or more corrective actions to mitigate the hazardous environmental condition without requiring a specific action or response by a user. The environmental condition that may be mitigated or corrected by the system 10 includes at least the air temperature within the interior space 14 of the vehicle 12. Thus, if a child 26 or pet is inadvertently left within the interior space 14 of the vehicle 12 and the air temperature within the interior space 14 becomes dangerously hot or cold, then the system 10 will automatically take immediate action to regulate the air temperature within the interior space 14 to a temperature that is safe for the child 26 or pet.

The system 10 comprises a vehicle 12 having an interior space 14. The interior space 14 is preferably defined at least partially by a window 16, as shown in FIG. 1, which shows a front window 16 and a rear window 16, both in a partially open position. As best seen in FIG. 2, which shows doors 15 and other portions of the vehicle 12 removed to illustrate certain components disposed within the interior space 14 of the vehicle 12, the system 10 further comprises a detection sensor 30 configured to detect an individual 26 occupying the interior space 14 of the vehicle 12 and an environmental sensor 32 configured to detect at least one environmental condition within the interior space 14 of the vehicle 12. The system 10 further comprises a controller 34 that receives an input signal 36 from the detection sensor 30 and an input signal 38 from the environmental sensor 32. As shown in FIG. 1, the vehicle 12 preferably includes at least one window motor 18 configured to move at least one window 16, and preferably each window 16 of the vehicle 12, between an open position and a closed position. As used herein, a “closed position” refers to a position in which a window 16 is completely or substantially closed such that no air or very little air can pass between the interior space 14 of the vehicle 12 and the external environment surrounding the vehicle 12. As used herein, an “open position” refers to a position in which a window 16 is completely or at least partially open to allow an airflow between the interior space 14 of the vehicle 12 and the external environment surrounding the vehicle 12 to a degree sufficient to substantially alter the air temperature within the interior space 14 due to the influence of an outside air temperature. Thus, both of the partially open windows 16 shown in FIG. 1 are in the open position. Each of the window motors 18 are preferably installed within an interior compartment of a door 15 or other side panel of the vehicle 12. Each window motor 18 is operatively connected to the controller 34 so that the controller 34 is capable of initiating operation of each window motor 18 to move each window 16 between the open and closed positions.

As shown in FIG. 2, the system 10 further comprises an air conditioner 20, which may be a standard HVAC unit 20 installed on the vehicle 12 during the process of manufacturing the vehicle 12. The air conditioner 20 is configured to control the air temperature within the interior space 14 of the vehicle 12. To this end, the air conditioner 20 may have one or more vents that are configured to distribute conditioned air, which may be heated or cooled, into the interior space 14 of the vehicle 12. The air conditioner 20 is operatively connected to the controller 34 so that the controller 34 is capable of initiating operation of the air conditioner 20 in either a cooling mode or a heating mode and also shutting down the air conditioner 20.

The environmental sensor 32 includes at least a thermometer configured to measure the air temperature within the interior space 14. In one embodiment, the environmental sensor 32 may include both a thermometer and a hygrometer, which may be a combination thermo-hygrometer, that is configured to measure both the air temperature and the humidity of the air within the interior space 14. The hygrometer may measure a relative humidity or an absolute humidity. In another embodiment, as discussed below, the environmental sensor 32 may further include a gas sensor 32A, which may be configured to detect and measure carbon dioxide (CO) gas. FIG. 2 illustrates a vehicle 12 having a plurality of environmental sensors 32 installed in different locations throughout the interior space 14. This configuration provides redundancy in the case of a failure of one sensor 32 and also allows strategic positioning of environmental sensors 32 within the interior space 14. For instance, separate thermometers 32 or combination thermo-hygrometers 32, may be installed near the front seats 25 and near the back seats 25 or any other rows of seats for vehicles 12 having multiple rows of seats. Separate thermometers 32 may also be installed near the roof of the interior space 14 of the vehicle 12 and also in lower positions within the interior space 14 to measure temperature readings at different locations within the interior space 14.

The detection sensor 30 may include one or more different types of sensors that are capable of detecting an individual 26 occupying the interior space 14 of the vehicle 12. Thus, the detection sensor 30 may include different types of sensors designed to function in combination to determine if an individual 26 is present within the interior space 14. Types of sensors 30 that may be utilized to detect the presence of an individual 26 include, but are not limited to, a weight sensor 30A, a camera, a motion sensor, a passive infrared sensor, a microphone, a vibration sensor, a time-of-flight sensor, an accelerometer, any combination thereof, or any other type of sensor suitable for detecting the presence of an individual 26. To determine if an individual 26 is present within the interior space 14 of the vehicle 12, the one or more sensors 30 may be configured detect a weight of an individual 26 sitting on a seat 25 of the vehicle 12, motions performed by the body of the individual 26 including sudden movements, vibrations caused by such motions or sudden movements, infrared light radiating from the body of the individual 26, sounds emitted by the individual 26, such as the sound of an individual speaking or calling for help or the sound of a dog barking, or any combination of these or other indicators of the presence of an individual 26. In some embodiments, a combination of detection sensors 30 may be utilized. For instance, in one preferred embodiment, a weight sensor 30A may be utilized in combination with another type of sensor that detects sound and/or motion produced by an individual 26. Thus, the weight sensor 30A may be used to detect the weight of the individual 26 on the seat 25 and the additional detection sensor 30 may be used to confirm that the weight is due to the presence of an individual 26 rather than being due to an inanimate object placed on the seat 25. In some embodiments, the one or more detection sensors 30 may include an artificial intelligence (AI) system designed to detect an individual 26 occupying the interior space 14. The AI system may include one or more cameras and may be trained to identify the presence of an individual 26 as a primary detection means or as a secondary detection means to confirm the presence of an individual 26 detected by other types of detection sensors 30.

FIG. 2 illustrates a vehicle 12 having a plurality of detection sensors 30 installed in different locations throughout the interior space 14. This configuration provides redundancy in the case of a failure of one sensor 32 and also allows strategic positioning of detection sensors 30 within the interior space 14. For instance, each seat 25 of the vehicle 12 may have a weight sensor 30A installed within the portion of the seat 25 that supports the weight of the individual 26, as shown in FIG. 2. Additional detection sensors 30 other than the weight sensors 30A may be installed within the interior space 14 in a position to detect the presence of an individual 26 sitting in either the front seats 25 or in the back seats 25 or in any other rows of seats for vehicles 12 having multiple rows of seats. For instance, detection sensors 30 may be installed on a back side of the front seats 25 to detect the presence of an individual 26 on the back seats 25, and additional detection sensors 30 may be installed in positions forward of the front seats 25 to detect the presence of an individual 26 on the front seats 25.

The controller 34 is preferably configured to initiate operation of one or more of the window motors 18 to move one or more of the windows 26 between the closed position and the open position and also to initiate operation of the air conditioner 20 to regulate the air temperature within the interior space 14 of the vehicle 12 when certain conditions are met. In a preferred embodiment, the controller 34 may be configured to initiate operation of one or more of the window motors 18 and/or the air conditioner 20 when, first, the one or more detection sensors 30 detect an individual 26 occupying the interior space 14 of the vehicle 12 and also when, second, the one or more environmental sensors 32 detect that the air temperature is outside of a threshold limit. The controller 34 may be installed on the vehicle 12 and wired to the one or more detection sensors 30, the one or more environmental sensors 32, the air conditioner 20, the window motors 18, and other optional components of the system 10, such as a wireless communications device 28. In a preferred embodiment, the controller 34 is a microcontroller comprising a processor 44, memory, and programmable inputs and outputs. Thus, the controller 34 is embedded within the system 10 and may have a dedicated function to automatically detect and mitigate harmful conditions under prescribed circumstances without requiring external action from a user of the system 10. The microcontroller 34 may be programmed to receive inputs from the sensors and control operation of the window motors 18 and air conditioner 20 based on the inputs. Further, the microcontroller 34 may be programmed to control operation of the window motors 18 and air conditioner 20 in one or more sequences of operational steps based on the inputs. The processor 44 may have machine readable instructions contained within the processor 44 such that execution of the instructions may direct the microcontroller 34 to function in a particular manner to carry out the dedicated function of the microcontroller 34.

In one embodiment, the one or more detection sensors 30, 30A collect personnel data 40 pertaining to the individual 26 occupying the interior space 14 of the vehicle 12. The personnel data 40 may include weight data, image data, video data, audio data, motion data, light data, or other similar data relevant to an individual 26 occupying the interior space 14 of the vehicle 12. In one embodiment, the one or more environmental sensors 32, 32A collect environmental data 42 pertaining to environmental conditions within the interior space 14 of the vehicle 12. The environmental data 42 may include temperature data, humidity data, atmospheric composition data, such as a concentration of a particular gas such as carbon monoxide, or other similar data relevant to environmental conditions within the interior space 14 of the vehicle 12. The controller 34 may receive the personnel data 40 from the one or more detection sensors 30, 30A and at least one environmental condition as indicated by the environmental condition data 42 from the one or more environmental sensors 32, 32A. The controller 34 may be configured to initiate operation of one or more of the window motors 18 to move one or more of the windows 26 between the closed position and the open position and also to initiate operation of the air conditioner 20 to regulate the air temperature within the interior space 14 of the vehicle 12 when, first, the personnel data 40 indicates that an individual 26 is within the interior space 14 of the vehicle 12 and also when at least one environmental condition is determined to be outside of a threshold limit as indicated by the environmental data 42. In one embodiment, the one or more detection sensors 30, 30A are configured to transmit the personnel data 40 to the processor 44 of the microcontroller 34, and the one or more environmental sensors 32, 32A are also configured to transmit the environmental data 42 to the processor 44 of the microcontroller 34.

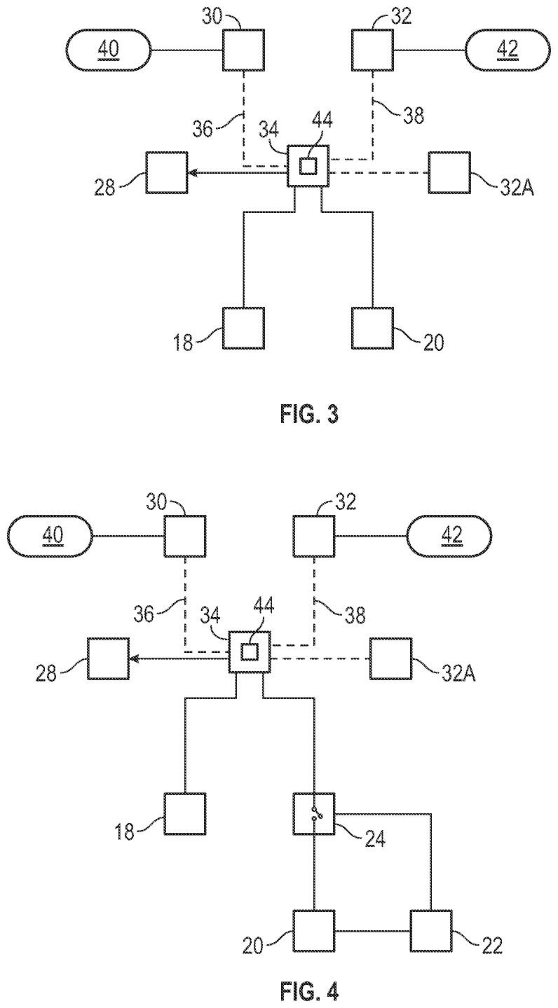

FIG. 3 illustrates a schematic diagram of components of the system 10. The system 10 may be configured to operate with a vehicle 12 having an internal combustion engine 22 configured to drive motion of the vehicle 12, as shown in FIG. 2, or, alternatively, with a vehicle 12 that does not have an internal combustion engine 22, such as an electric vehicle powered by an electric motor that draws power from an on-board battery. In embodiments of the system 10 having an internal combustion engine 22, the vehicle 12 may also include a starter switch 24 configured to activate operation of the engine 22, for instance when a driver starts the vehicle 12. In this embodiment, the controller 34 may be further configured to switch on the starter switch 24 to activate operation of the engine 22, which may then allow the controller 34 to initiate operation of the air conditioner 20 and the window motors 18. FIG. 4 illustrates a schematic diagram of components of the system 10 including a starter switch 24 configured to allow the controller 34 to initiate and control operation of the air conditioner 20 and the window motors 18 once the engine 22 has been started. The controller 34 may be configured to initiate operation of the combustion engine 22 automatically without requiring action by the driver when certain conditions are met, namely when the detection sensor 30 detects an individual 26 occupying the interior space 14 of the vehicle 12 and also when the environmental sensor 32 detects that the air temperature within the interior space 14 of the vehicle 12 is outside of a threshold limit. In embodiments of the system 10 having an electric motor, the controller 34 may be configured to directly initiate and control operation of the air conditioner 20 and the window motors 18, as shown in FIG. 3.

The system 10 is designed to automatically regulate the air temperature within the interior space 14 of the vehicle 12 whenever an individual 26 is occupying the interior space 14 and the air temperature is outside of a threshold limit. In one embodiment, the threshold limit may be an upper threshold limit, in which case the system 10 may protect the individual 26 from extreme heat within the interior space 14 of the vehicle 12. In another embodiment, the threshold limit may be a lower threshold limit, in which case the system 10 may protect the individual 26 from extreme cold temperatures within the interior space 14 of the vehicle 12. The microcontroller 34 may be programmed to initiate operation of either a cooling function or a heating function of the air conditioner unit 20 based on whether the input 38 from the environmental sensor 32 indicates a temperature above the upper threshold limit or below the lower threshold limit. The upper and lower thresholds may be programmed at two different temperature setpoints. For instance, in one example embodiment, the temperature setpoint for the lower threshold limit may be 60 degrees Fahrenheit, and the temperature setpoint for the upper threshold limit may be 85 degrees Fahrenheit. Thus, if the air temperature within the interior space 14 of the vehicle 12 drops below 60 degrees, the controller 34 may be programmed to take a defined set of actions to raise the air temperature, and if the air temperature within the interior space 14 of the vehicle 12 rises above 85 degrees, the controller 34 may be programmed to take a different defined set of actions to lower the air temperature.

In one embodiment in which the environmental sensor 32 includes both a thermometer and a hygrometer, the controller 34 may be programmed to calculate an adjusted setpoint based on the relative humidity of the air within the interior space 14. For instance, the setpoint for the upper threshold limit may be adjusted to a lower setpoint in cases in which the hygrometer detects a high relative humidity. For example, if the hygrometer detects a relative humidity of 70% or higher, the controller 34 may be programmed to adjust the setpoint of the upper threshold limit from 85 degrees to 80 degrees since a lower actual temperature may be dangerous to individuals 26 when humidity levels are high.

In the case in which the system 10 is initiated to regulate the air temperature when the air temperature is excessively hot, upon receiving an input signal 36 from the detection sensor 30 indicating that the air temperature is higher than the upper threshold limit, the controller 34 may be configured to initiate operation of the air conditioner 20 to cool the air within the interior space 14 of the vehicle 12. In vehicles 12 having a combustion engine 22, the controller 34 may switch on the starter switch 24 and activate the engine 22 before initiating operation of the air conditioner 20 if the engine 22 is not already running. When the cooling function of the air conditioner 20 is activated by the controller 34, an air temperature setpoint may be automatically set for the air conditioner 20 at a temperature that is safe for the individual 26 occupying the interior space 14. For instance, the air temperature setpoint may be set at 70 degrees Fahrenheit so that the air conditioner 20 operates to maintain the air temperature at 70 degrees until the system 10 is deactivated. The system 10 may be automatically deactivated by certain external actions performed by a user, such as the user manually deactivating the engine 22 of the vehicle 12 or manually changing a setting on the air conditioner 20, such as deactivating the air conditioner 20 or changing a temperature setting of the air conditioner 20. Other external actions that may automatically deactivate the system 10 may include removing the individual 26 from the interior space 14 of the vehicle 12 so that the detection sensors 30 no longer detect the presence of the individual 26. Such external actions may generally indicate that the individual 26 in the vehicle 12 is safe from a hazardous environmental condition within the vehicle 12.

In a preferred embodiment, the controller 34 may be configured to initiate operation of the window motor 18 and the air conditioner 20 in a sequence based on the input signal 36 from the detection sensor 30 and the input signal 38 from the environmental sensor 32. In one embodiment in which the system 10 is initiated to regulate the air temperature when the air temperature is excessively hot, the sequence comprises: (1) first initiating operation of the window motor 18 to move one or more of the windows 16 from the closed position to the open position, (2) then initiating operation of the air conditioner 20 to regulate the air temperature within the interior space 14 of the vehicle 12, and (3) then initiating operation of the window motor 18 to move the one or more windows 16 from the open position to the closed position. In this embodiment, the controller 34 may first initiate operation of the window motor 18 to move at least one window 16, and preferably at least two windows 16, from the closed position to the open position to immediately alleviate extreme heat within the interior space 14. The controller 34 may then initiate operation of the air conditioner 20 to begin the process of cooling the air temperature within the interior space 14 after or at the same time as moving the window 16 to the open position. The air conditioner 20 helps to further regulate and cool the interior air temperature. The controller 34 may then initiate operation of the window motor 18 to move the window 16 from the open position back to the closed position so that the air conditioner 20 can cool the interior air temperature to a temperature below the outside air temperature and regulate and maintain the temperature at the setpoint, which is preferably around 70 degrees. Alternatively, if all windows 16 are in the closed position at the time the system 10 is initiated to regulate the air temperature, the controller 34 may be configured to proceed directly to initiating operation of the air conditioner 20 to regulate the air temperature within the interior space 14 while leaving the windows 16 in the closed position.

In a preferred embodiment, the controller 34 may be further configured to initiate operation of the window motor 18 to move one or more of the windows 16 to the open position if the air conditioner 20 is deactivated. For instance, if the system 10 is installed on a vehicle 12 having a combustion engine 22 and the engine 22 runs out of fuel and shuts down, the air conditioner 20 will be automatically deactivated after the engine 22 shuts down. The air conditioner 20 may also be considered to be deactivated if there is a problem with the air conditioner 20 that prevents it from maintaining an interior air temperature setpoint even if it continues to emit air into the interior space 14. In such a case, if the environment outside the vehicle 12 is extremely hot then it may be preferable to keep the windows 16 in the open position since the air conditioner 20 will not be able to cool the interior space 14 when it is deactivated, and leaving the windows 16 in the closed position would likely cause the air temperature in the interior space 14 to be hotter than leaving the windows 16 in the open position. In one embodiment, the controller 34 may be programmed to move the windows 16 to a default open position if the air conditioner 20 is deactivated and the air temperature is higher than the upper threshold limit and to move the windows 16 to a default closed position if the air conditioner 20 is deactivated and the air temperature is lower than the lower threshold limit.

In the case in which the system 10 is initiated to regulate the air temperature when the air temperature is excessively cold, upon receiving an input signal 36 from the detection sensor 30 indicating that the air temperature is lower than the lower threshold limit, the controller 34 may be configured to initiate operation of the air conditioner 20 to heat the air within the interior space 14 of the vehicle 12. In vehicles 12 having a combustion engine 22, the controller 34 may switch on the starter switch 24 and activate the engine 22 before initiating operation of the air conditioner 20 if the engine 22 is not already running. When the heating function of the air conditioner 20 is activated by the controller 34, an air temperature setpoint may be automatically set for the air conditioner 20 at a temperature that is safe for the individual 26 occupying the interior space 14. For instance, the air temperature setpoint may be set at 70 degrees Fahrenheit so that the air conditioner 20 operates to maintain the air temperature at 70 degrees until the system 10 is deactivated, which may occur automatically upon certain external actions performed by a user.

In the embodiment in which the system 10 is initiated to regulate the air temperature when the air temperature is excessively cold, the sequence of initiating operation of the window motor 18 and the air conditioner 20 may comprise: (1) first initiating operation of the window motor 18 to move one or more of the windows 16 from the open position to the closed position if any of the windows 16 are in the open position, and (2) then initiating operation of the air conditioner 20 to regulate the air temperature within the interior space 14 of the vehicle 12. In this embodiment, the controller 34 may first initiate operation of the window motor 18 to move any open window 16 to the closed position to contain warm air emitted by the air conditioner 20. The controller 34 may then initiate operation of the air conditioner 20 to begin the process of heating the air temperature within the interior space 14 after or at the same time as moving the windows 16 to the closed position. The air conditioner 20 may then heat the interior air temperature to a temperature above the outside air temperature and regulate and maintain the temperature at a setpoint that is preferably around 70 degrees.

In a preferred embodiment, the system 10 further comprises a gas sensor 32A, which may be configured to detect and measure any harmful gases either within the interior space 14 or in the environment surrounding the exterior of the vehicle 12. The gas sensor 32A is preferably configured to detect and measure at least carbon dioxide (CO) gas and optionally other gases that may be harmful to an individual 26. One or more gas sensors 32A are preferably disposed within the interior space 14 of the vehicle 12, as shown in FIG. 2, but the system 10 may also include one or more additional gas sensors 32A disposed in a location where the gas sensors 32A can detect and measure harmful gases on the exterior of the vehicle 12, such as within a wheel well of the vehicle, as shown in FIG. 1. If an individual 26 is left occupying the interior space 14 of the vehicle 12 while the vehicle 12 is parked within an enclosed space, such as a residential garage, and the air temperature within the interior space 14 deviates to a temperature that is outside of the upper and lower threshold limits, then the controller 34 will switch on the starter switch 24 to activate operation of the engine 22 of vehicles 12 having a combustion engine 22, which produces carbon monoxide gas that can be deadly to occupants of the vehicle 12. To protect the individual 26 occupying the vehicle 12 or any other individual outside the vehicle 12 from negative effects from carbon monoxide gas or other harmful gases, the controller 34 is further configured to switch off the starter switch 24 to deactivate operation of the engine 22 when the gas sensors 32A detect the presence of the harmful gas, thereby stopping production of harmful gases from the engine 22.

In a preferred embodiment, the controller 34 may be configured to shut down the engine 22 whether the gas sensor 32A that detects the presence of a harmful gas is disposed within the interior space 14 or outside of the interior space 14. In most cases in which the system 10 activates operation of the engine 22 to regulate the air temperature in the interior space 14, the windows 16 will be in the closed position during most of the time that the engine 22 is running, and thus the gas sensor 32A outside the interior space 14 will first detect carbon monoxide gas before the gas sensor 32A inside the interior space 14 since the source of carbon monoxide gas is outside of the interior space 14. In this case, the controller 34 will automatically deactivate operation of the engine 22 upon detection of carbon monoxide above a threshold limit. In any cases in which one or more windows 16 are in the open position for any reason, the controller 34 may be configured to initiate operation of the window motor 18 to move all windows 16 from the open position to the closed position when both the one or more windows 16 are in the open position and also when the gas sensors 32A detect the presence of a harmful gas. By closing all windows 16, the system 10 may protect the individual 26 occupying the vehicle 12 from further exposure to the harmful gas. By having a gas sensor 32A external to the interior space 14, the system 10 may also protect any individual who approaches the vehicle 12 to aid the individual 26 occupying the interior space 14. The gas sensor 32A within the interior space 14 may serve as a backup to ensure that the individual 26 occupying the interior space 14 is not harmed.

FIG. 5 illustrates a method 100 of using the system 10 for detecting an individual 26 and automatically taking corrective actions to mitigate harmful environmental conditions to protect the individual 26 from serious injury or death. In step 50, the system 10 detects whether an individual 26, which may include a human or an animal, is occupying the interior space 14 of the vehicle 12 using one or more detection sensors 30 configured to detect the presence of an individual 26 located within the interior space 14 of the vehicle 12. If the system 10 does not detect an individual 26 occupying the interior space 14 of the vehicle 12, then the method 100 proceeds directly to step 62 at which point the method 100 ends. In step 52, the system 10 detects whether an environmental condition is outside of a threshold limit and particularly whether the air temperature within the interior space 14 of the vehicle 12 is outside of a threshold limit using one or more environmental sensors 32 configured to detect the air temperature or other environmental conditions. If the system 10 does not detect an environmental condition outside of a threshold limit within the interior space 14 of the vehicle 12, then the method 100 proceeds directly to step 62 at which point the method 100 ends.

If the system 10 detects an individual 26 occupying the interior space 14 of the vehicle 12 and also detects an air temperature outside of a threshold limit within the interior space 14 of the vehicle 12, then the method 100 proceeds to step 54 where the system 10 determines whether the air temperature within the interior space 14 of the vehicle 12 is above an upper threshold limit or below a lower threshold limit. If the air temperature is above the upper threshold limit, then the method 100 preferably proceeds to step 56, and if the air temperature is below the lower threshold limit, then the method 100 proceeds to step 58. In step 56, if the air temperature is above the upper threshold limit, then the controller 34 may initially move one or more of the windows 16 to the open position to alleviate the heat within the interior space 14. In step 58, the controller 34 activates the air conditioner 20 to regulate the air temperature within the interior space 14 of the vehicle 12 to bring the air temperature to a setpoint or an acceptable temperature range that is safe for the individual 26 occupying the interior space 14. To regulate the air temperature, the controller 34 may activate either a cooling function or a heating function of the air conditioner 20 depending on whether the air temperature is above the upper threshold or below the lower threshold. After activating the air conditioner 20 to regulate the air temperature, the method 100 proceeds to step 60 in which the controller 34 moves all windows 16 to the closed position if any windows 16 are in the open position. If the air temperature is below the lower threshold limit, the method 100 may proceed to step 60 immediately after or at the same time as step 58. If the air temperature is above the upper threshold limit, the method 100 may proceed to step 60 after a short delay after the air conditioner 20 is activated in step 58 to allow time for the air conditioner 20 to start cooling the interior space 14 before closing the windows 16, which may generally contribute to increasing the interior air temperature within the interior space 14. Once the windows 16 are all in the closed position and the air conditioner 20 has regulated the air temperature to an acceptable level, the system 10 may maintain the air temperature at an acceptable level until the method 100 is terminated at step 62.

In a preferred embodiment, the system 10 may further comprise a wireless communication device 28 configured to connect the vehicle 12 to a wireless network. In one embodiment, when system 10 detects an individual 26 occupying the interior space 14 of the vehicle 12 and also detects an air temperature outside of a threshold limit within the interior space 14 of the vehicle 12, then the controller 34 may be configured to automatically send a signal indicating a potential emergency situation via the wireless communication device 28. For instance, the wireless communication device 28 may send a signal to emergency services that a person or pet needs assistance. The wireless communication device 28 may also include a geolocation device that may collect geospatial information related to a geolocation of the vehicle 12. The geolocation device may be a component of a Global Positioning System (GPS) receiver module, which may be connected to the wireless communication device 28. Thus, the wireless communication device 28 may be capable of sending an emergency signal and a geolocation of the vehicle 12 to emergency services to locate the vehicle 12 and provide aid to the individual 26 within the vehicle 12. Because the system 10 is able to automatically regulate the interior air temperature to a safe level, the individual 26 may be kept safe until emergency services arrive at the vehicle 12 to provide aid.

It will be appreciated that the configurations and methods shown and described herein are illustrative only, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein. It is understood that versions of the invention may come in different forms and embodiments. Additionally, it is understood that one of skill in the art would appreciate these various forms and embodiments as falling within the scope of the invention as disclosed herein.

What is claimed is:

1) A system comprising:
a vehicle having an interior space, wherein the vehicle comprises an air conditioner configured to control an air temperature within the interior space of the vehicle;
a detection sensor configured to detect an individual occupying the interior space of the vehicle;
an environmental sensor configured to detect at least one environmental condition within the interior space of the vehicle, wherein the at least one environmental condition includes at least the air temperature within the interior space of the vehicle; and
a controller that receives an input signal from the detection sensor and an input signal from the environmental sensor,
wherein the controller is configured to initiate operation of the air conditioner to regulate the air temperature within the interior space of the vehicle when both (1) the detection sensor detects an individual occupying the interior space of the vehicle, and also when (2) the environmental sensor detects that the air temperature is outside of the threshold limit.

2) The system of claim 1, wherein the detection sensor comprises a weight sensor, a motion sensor, an infrared sensor, a microphone, or any combination thereof.

3) The system of claim 1, wherein the environmental sensor comprises a thermometer and a hygrometer.

4) The system of claim 1, wherein the interior space is defined at least partially by a window, wherein the vehicle further comprises a window motor configured to move the window between an open position and a closed position, wherein the controller is further configured to initiate operation of the window motor to move the window between the closed position and the open position when both (1) the detection sensor detects an individual occupying the interior space of the vehicle, and also when (2) the environmental sensor detects that the air temperature is outside of a threshold limit.

5) The system of claim 4, wherein the controller is configured to initiate operation of the window motor and the air conditioner in a sequence based on the input signal from the detection sensor and the input signal from the environmental sensor, wherein the sequence comprises: (1) first initiating operation of the window motor to move the window from the closed position to the open position, (2) then initiating operation of the air conditioner to regulate the air temperature within the interior space of the vehicle, and (3) then initiating operation of the window motor to move the window from the open position to the closed position.

6) The system of claim 4, further comprising a gas sensor, wherein the controller is configured to initiate operation of the window motor to move the window from the open position to the closed position when both (1) the window is in the open position, and also when (2) the gas sensor detects the presence of a harmful gas.

7) The system of claim 1, wherein the vehicle further comprises an engine configured to drive motion of the vehicle and a starter switch configured to activate operation of the engine, wherein the controller is further configured to switch on the starter switch to activate operation of the engine.

8) The system of claim 1, wherein the threshold limit is an upper threshold limit, wherein the controller is further configured to initiate operation of the air conditioner to cool air within the interior space of the vehicle when the air temperature is higher than the upper threshold limit.

9) The system of claim 1, wherein the threshold limit is a lower threshold limit, wherein the controller is further configured to initiate operation of the air conditioner to heat air within the interior space of the vehicle when the air temperature is lower than the lower threshold limit.

10) The system of claim 1, further comprising a gas sensor, wherein the vehicle further comprises an engine configured to drive motion of the vehicle and a starter switch configured to activate operation of the engine, wherein the controller is further configured to switch off the starter switch to deactivate operation of the engine when the gas sensor detects the presence of a harmful gas.

11) A method comprising the steps of:
providing a system comprising:
a vehicle having an interior space, wherein the interior space is defined at least partially by a window, wherein the vehicle comprises a window motor configured to move the window between an open position and a closed position, wherein the vehicle further comprises an air conditioner configured to control an air temperature within the interior space of the vehicle,
a detection sensor configured to detect an individual occupying the interior space of the vehicle,
an environmental sensor configured to detect at least one environmental condition within the interior space of the vehicle, wherein the at least one environmental condition includes at least the air temperature within the interior space of the vehicle, and
a controller that receives an input signal from the detection sensor and an input signal from the environmental sensor,
wherein the controller is configured to initiate operation of the window motor to move the window between the closed position and the open position when both (1) the detection sensor detects an individual occupying the interior space of the vehicle, and also when (2) the environmental sensor detects that the air temperature is outside of a threshold limit, and
wherein the controller is further configured to initiate operation of the air conditioner to regulate the air temperature within the interior space of the vehicle when both (1) the detection sensor detects an individual occupying the interior space of the vehicle, and also when (2) the environmental sensor detects that the air temperature is outside of the threshold limit;
the detection sensor detecting an individual occupying the interior space of the vehicle;
the environmental sensor detecting the air temperature within the interior space of the vehicle being outside of the threshold limit;
the controller initiating operation of the window motor to move the window from the closed position to the open position; and
the controller initiating operation of the air conditioner to regulate the air temperature within the interior space of the vehicle.

12) The method of claim 11, further comprising the step of the controller initiating operation of the window motor to move the window from the open position to the closed position after the air conditioning has regulated the air temperature so that the air temperature is within the threshold limit.

13) The method of claim 11, wherein the vehicle further comprises an engine configured to drive motion of the vehicle and a starter switch configured to activate operation of the engine, wherein the controller is further configured to switch on the starter switch to activate operation of the engine, wherein the method further comprises the step of the controller switching on the starter switch to activate operation of the engine before the step of the controller initiating operation of the window motor.

14) The method of claim 11, wherein the threshold limit is an upper threshold limit, wherein the step of the controller initiating operation of the air conditioner to regulate the air temperature within the interior space of the vehicle comprises the controller initiating operation of the air conditioner to cool air within the interior space of the vehicle when the air temperature is higher than the upper threshold limit.

15) The method of claim 11, wherein the threshold limit is a lower threshold limit, wherein the step of the controller initiating operation of the air conditioner to regulate the air temperature within the interior space of the vehicle comprises the controller initiating operation of the air conditioner to heat air within the interior space of the vehicle when the air temperature is lower than the lower threshold limit.

16) A system comprising:
a vehicle having an interior space, wherein the interior space is defined at least partially by a window, wherein the vehicle comprises a window motor configured to move the window between an open position and a closed position, wherein the vehicle further comprises an air conditioner configured to control an air temperature within the interior space of the vehicle;
a detection sensor configured to detect an individual occupying the interior space of the vehicle, wherein the detection sensor collects personnel data pertaining to the individual;
an environmental sensor configured to detect at least one environmental condition within the interior space of the vehicle, wherein the at least one environmental condition includes at least the air temperature within the interior space of the vehicle; and
a controller that receives personnel data from the detection sensor and the at least one environmental condition from the environmental sensor,
wherein the controller is configured to initiate operation of the window motor to move the window between the closed position and the open position when both (1) the personnel data indicates that the individual is within the interior space of the vehicle, and also when (2) the at least one environmental condition is determined to be outside of a threshold limit, and
wherein the controller is further configured to initiate operation of the air conditioner to regulate the air temperature within the interior space of the vehicle when both (1) the personnel data indicates that the individual is within the interior space of the vehicle, and also when (2) the at least one environmental condition is determined to be outside of the threshold limit.

17) The system of claim 16, wherein the detection sensor comprises a weight sensor, a motion sensor, an infrared sensor, a microphone, or any combination thereof.

18) The system of claim 16, wherein the environmental sensor comprises a thermometer and a hygrometer.

19) The system of claim 16, wherein the vehicle further comprises an engine configured to drive motion of the vehicle and a starter switch configured to activate operation of the engine, wherein the controller is further configured to switch on the starter switch to activate operation of the engine.

20) The system of claim 16, wherein the controller is configured to initiate operation of the window motor and the air conditioner in a sequence, wherein the sequence comprises: (1) first initiating operation of the window motor to move the window from the closed position to the open position, (2) then initiating operation of the air conditioner to regulate the air temperature within the interior space of the vehicle, and (3) then initiating operation of the window motor to move the window from the open position to the closed position.
